(19) United States
(12) Patent Application Publication
(10) Pub. No.: US 2026/0219850 A1
(43) Pub. Date: Jul. 30, 2026

(54) GENERATING POINTS-TO RELATIONS USING LANGUAGE MODELS

(71) Applicant: Oracle International Corporation, Redwood Shores, CA (US)

(72) Inventors: Mahinthan CHANDRAMOHAN, Brisbane (AU); Padmanabhan KRISHNAN, Brisbane (AU)

(73) Assignee: Oracle International Corporation, Redwood Shores, CA (US)

(21) Appl. No.: 19/037,869

(22) Filed: Jan. 27, 2025

(51) Int. Cl. G06F 8/41

(52) U.S. Cl. CPC G06F 8/436; G06F 8/443

(57) ABSTRACT

A method implements generating points-to relations using language models. The method involves executing a preprocessing session using one or more language models to process source code using one or more preprocessing prompts to generate metadata from the source code. The method further involves executing an analysis session using the one or more language models to process the metadata using an analysis prompt to generate a points-to report for the source code from the metadata. The method further involves executing an evaluation session using the one or more language models to process the points-to report and normalized code from the metadata using an evaluation prompt to generate a revised points-to report. The revised points-to report includes a confidence score for an entry in the points-to report.

### BACKGROUND

Points-to analysis is a static code analysis technique that may be used to determine the set of memory locations (or objects) that a pointer variable may point to during program execution. A challenge with performing points-to analysis is that tools performing points-to analysis may operate on compilable code but not on incomplete code. Language models may be used to perform many types of analysis and may gracefully handle incomplete input. A challenge with language models is to perform points-to analysis without false positives or false negatives.

### SUMMARY

In general, in one or more aspects, the disclosure relates to a method for generating points-to relations using language models. The method involves executing a preprocessing session using one or more language models to process source code using one or more preprocessing prompts to generate metadata from the source code. The method further involves executing an analysis session using the one or more language models to process the metadata using an analysis prompt to generate a points-to report for the source code from the metadata. The method further involves executing an evaluation session using the one or more language models to process the points-to report and normalized code from the metadata using an evaluation prompt to generate a revised points-to report. The revised points-to report includes a confidence score for an entry in the points-to report.

In general, in one or more aspects, the disclosure relates to a system that includes at least one processor and an application that executes on the at least one processor. Executing the application performs a preprocessing session using one or more language models to process source code using one or more preprocessing prompts to generate metadata from the source code. Executing the application further performs an analysis session using the one or more language models to process the metadata using an analysis prompt to generate a points-to report for the source code from the metadata. Executing the application further performs an evaluation session using the one or more language models to process the points-to report and normalized code from the metadata using an evaluation prompt to generate a revised points-to report. The revised points-to report includes a confidence score for an entry in the points-to report.

In general, in one or more aspects, the disclosure relates to a non-transitory computer readable medium including instructions executable by at least one processor. Executing the instructions performs a preprocessing session using one or more language models to process source code using one or more preprocessing prompts to generate metadata from the source code. Executing the instructions further performs an analysis session using the one or more language models to process the metadata using an analysis prompt to generate a points-to report for the source code from the metadata. Executing the instructions further performs an evaluation session using the one or more language models to process the points-to report and normalized code from the metadata using an evaluation prompt to generate a revised points-to report. The revised points-to report includes a confidence score for an entry in the points-to report.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, and FIG. 5, show examples in accordance with the disclosure.

FIG. 6A and FIG. 6B show computing systems in accordance with the disclosure.

Similar elements in the various figures may be denoted by similar names and reference numerals. The features and elements described in one figure may extend to similarly named features and elements in different figures.

### DETAILED DESCRIPTION

An embodiment of the disclosure generates points-to relations using language models (e.g., large language models (LLMs)). The language model may be used to execute a points-to analysis and generate a points-to report that minimizes the number of false positives and false negatives. Multiple sessions with multiple prompts may be used to generate the points-to report for given source code. A preprocessing session may process the source code prior to performing the points-to analysis to generate metadata used during the points-to analysis. An analysis session may process the metadata with a normalized version of the code to generate an initial version of a points-to report. After generating the points-to report, an evaluation session may operate one or more times to generate confidence scores for the entries in the points-to report. When the evaluation session is performed multiple times, the multiple confidence scores for individual entries in the points-to report may be aggregated to form aggregated confidence values collected within an aggregated points-to report.

The points-to report generated using the language model may be used for security analysis, to generate optimized code, to provide suggestions in integrated development environments (IDEs), etc. The security analysis may use the points-to report to identify tainted variables and sink functions and identify whether additional variables alias to the tainted variables to indicate that the additional variables are to be sanitized before being used by the sink function. The optimized code may be generated with a compiler that uses the points-to report to identify optimizations they may be utilized to reduce code size, code execution time, etc. The IDE may execute the points-to analysis on a fragment of code that is incomplete and not compilable to display alias information and provide suggestions for improving the code in the integrated development environment.

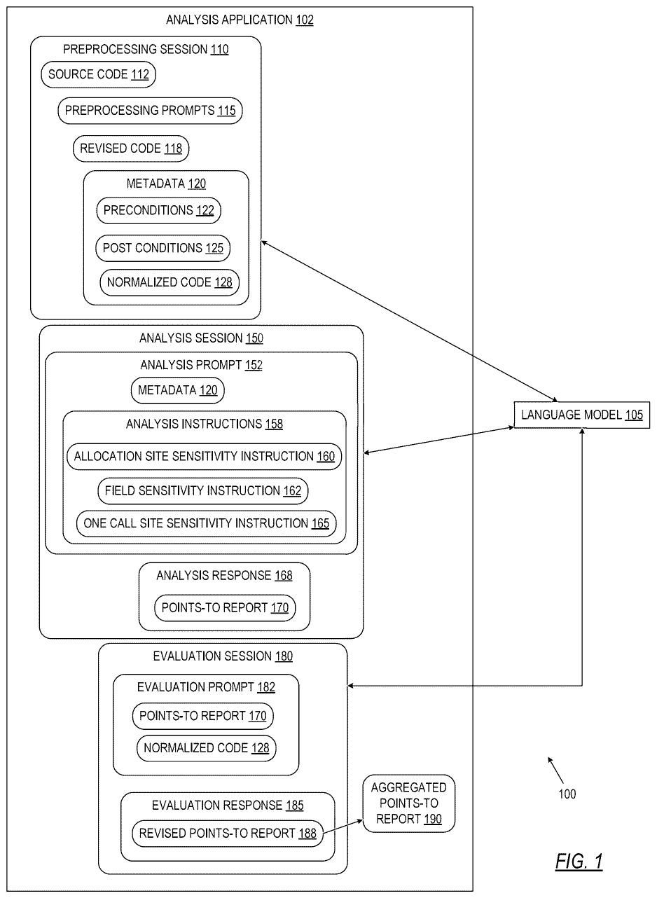

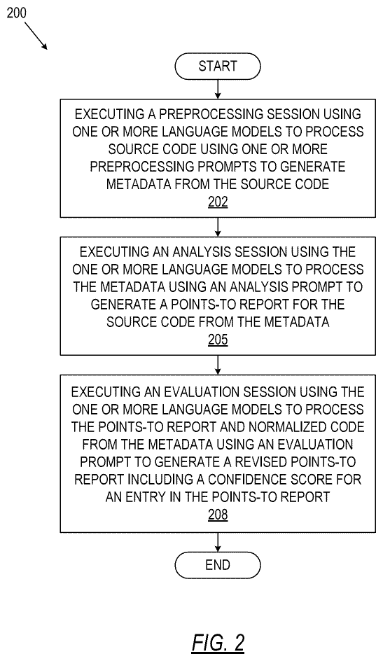

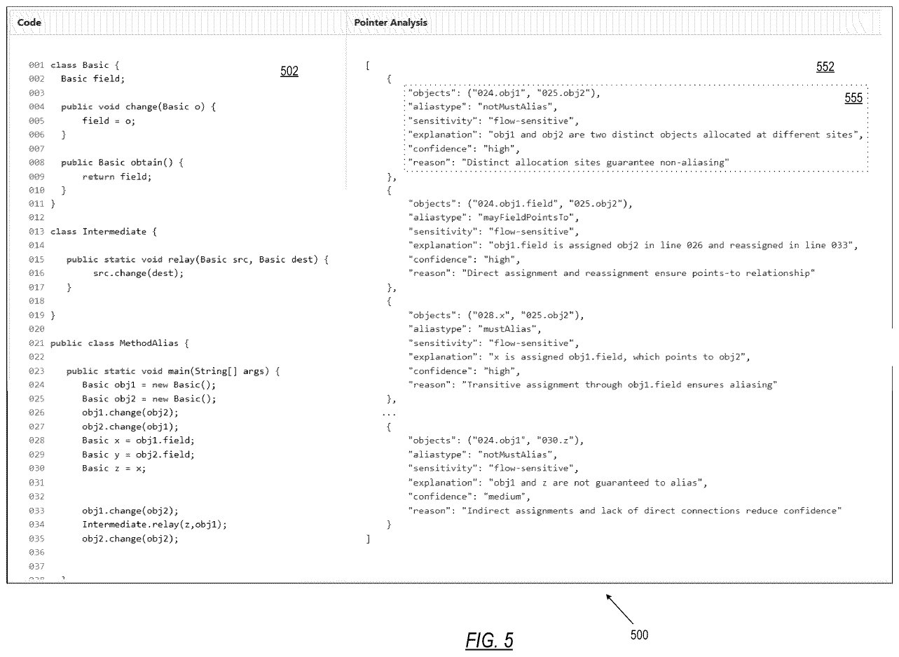

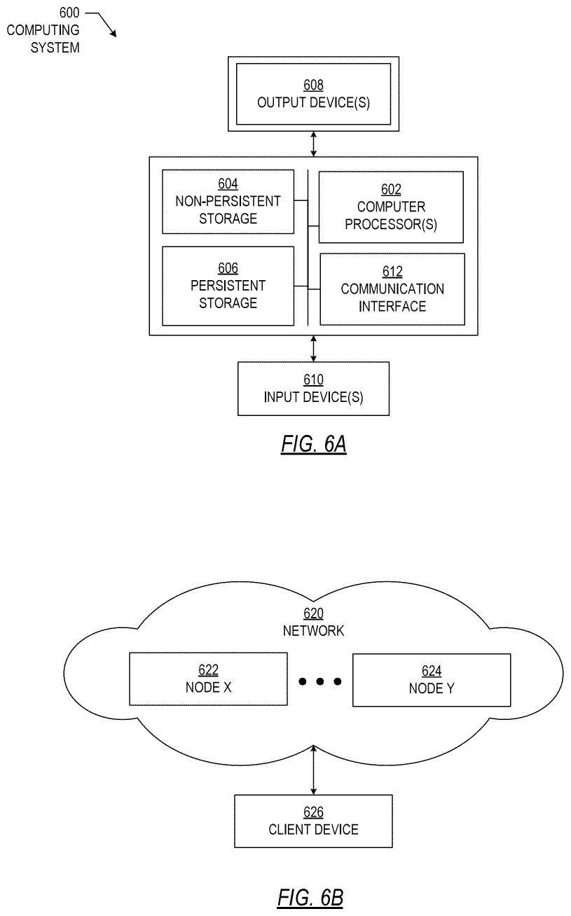

Turning to FIG. 1, the system (100) is implemented with one or more computing systems (such as the computing system (600) of FIG. 6) to process the source code (112) to generate the aggregated points-to report (190) using the analysis application (102) and the language model (105). The analysis application (102) and the language model (105) may operate on the same or different computing systems. The analysis application (102) and the language model (105) may each be distributed and executed on multiple computing systems.

The analysis application (102) is a program that processes the source code (112) using the language model (105). The analysis application (102) may include a user interface, which may be of an integrated development environment (IDE) that receives, processes, transmits, and displays data. The data displayed may include the data processed by the system (100), including the text of the sessions (110), (150), and (180) as well as the source code (112), the metadata (120), the points-to report (170), the revised points-to report (188), the aggregated points-to report (190), etc. The analysis application (102) uses multiple sessions including the preprocessing session (110), the analysis session (150), and the evaluation session (180).

The language model (105), which may be a large language model (LLM), is a machine learning model that processes natural language in the form of text. The language model (105) receives input text (referred to as a prompt) that is processed to generate output text (referred to as a response to the prompt). The language model (105) may include a neural network model that may include transformer-based models with attention to convert the text to tokens, convert the tokens to vector embeddings, process the vector embeddings to generate output vectors, generate output tokens from the output vectors, and generate the output text from the output tokens. The language model (105) may include one or multiple language models that may be used to independently process different sessions and independently process different prompts. The language model (105) may be a single model that processes the sessions sequentially. The language model (105) may be a multi modal model that may process types of data in addition to text, such as images, video, etc.

The preprocessing session (110) is the text exchanged with the language model (105) to generate the metadata (120) from the source code (112). The preprocessing session (110) includes the source code (112), the preprocessing prompts (115), the revised code (118), and the metadata (120).

The source code (112) is a set of human-readable instructions written in a programming language that defines the operations and functions of a computer program before the program is compiled into machine code and executed by the computer. Examples of the programming languages include Python, Java, JavaScript, C++, C #, Ruby, Swift, assembly language, etc. The source code (112) may define objects that include methods and fields that may be used to store and process data. The source code (112) may be included in one or more of the processing prompts (115) to be processed by the language model (105). The source code (112) may be a fragment (i.e., a code fragment) that is incomplete and may not be compilable.

The preprocessing prompts (115) are collections of data (e.g., text) for the language model (105). The preprocessing prompts (115) include instructions that may be executed by the language model (105) to generate multiple responses that may include the revised code (118) and the metadata (120). The preprocessing prompts (115) may also include data (e.g., the source code (112)) that is processed responsive to the instructions. A response may be generated for each of the preprocessing prompts (115). Different ones of the preprocessing prompts (115) may generate different outputs. For example, one of the preprocessing prompts (115) may generate the revised code (118) in a response, another one of the preprocessing prompts (115) may generate the preconditions (122) and the post conditions (125) in another response, and another one of the preprocessing prompts (115) may generate the normalized code (128) in another response. Multiple prompts may be used to generate the preconditions (122) and the post conditions (125). The preprocessing prompts (115) may be input to the language model (105) based on a defined sequence to generate outputs from the language model (105) in a specified order. For example, the revised code (118) may be generated before the preconditions (122) and the post conditions (125), which may be generated before the normalized code (128).

The revised code (118) is code generated from the source code (112). The revised code (118) may include the source code (112) after removing unreachable code from the source code (112). The removal of the unreachable code may be in response to one of the preprocessing prompts (115).

The metadata (120) is a collection of output from the language model (105) that is generated from the source code (112) responsive to one or more of the preprocessing prompts (115). The metadata (120) includes the preconditions (122), the post conditions (125), and the normalized code (128).

The preconditions (122) are text generated by the language model (105) based on the source code (112). A precondition is a logical operation that evaluates to true before a method defined in the source code (112) may be executed. If the precondition for a method does not evaluate to true and the method executes, then the program may not be operating properly. The text output from the language model for a precondition may include the logical operation that defines the precondition.

The post conditions (125) are text generated by the language model (105) based on the source code (112). A post condition is a logical operation that evaluates to true after a method defined in the source code (112) is executed. If the post condition for a method does not evaluate to true after the method executes, then the program may not be operating properly. The text output from the language model for a post condition may include the logical operation that defines the post condition.

The normalized code (128) is code generated from the source code (112). The normalized code (128) may be a further revised version of the revised code (118) that retains a specified set of statements. For example, the specified statements may include statements related to memory allocation. The statements from the source code (112) that do not relate to memory allocation may be removed to form the normalized code (128). As an example, memory allocation statements may include statements similar to:
“v=new O( )” a statement allocating memory for an object (v);
“v1=v2” a statement performing an assignment between objects (v1 and v2);
“v1=v2.f” a statement loading from a field (i.e., from v2.f);
“vl.f=v2” a statement storing to a field (i.e., to v1.f); and
“call c.m( )” a statement calling the method (m) of the class (c), where c represents the fully qualified class name.

The analysis session (150) is the text exchanged with the language model (105) to generate the points-to report (170) from the metadata (120). The analysis session (150) includes the analysis prompt (152) and the analysis response (168).

The analysis prompt (152) is a collection of data and instructions used to generate the points-to report (170) from the metadata (120). The analysis prompt (152) includes the metadata (120) and the analysis instructions (158).

The metadata (120) (further described above) may be included with the analysis prompt (152). The metadata (120) may be included as text within the analysis prompt (152) or may be included as a separate file provided with the analysis prompt (152) to the language model (105).

The analysis instructions (158) are instructions to the language model (105) for performing a points-to analysis using the metadata (120). The analysis instructions (158) may include instructions that control the operation of the points-to analysis. As an example, the analysis instructions (158) may include instructions to use specified sensitivities such as the allocation site sensitivity instruction (160), the field sensitivity instruction (162), and the one call site sensitivity instruction (165).

The allocation site sensitivity instruction (160), which may also be referred to as object-sensitivity, instructs the language model (105) to use allocation sites as context elements to distinguish between different instances of objects created at different points (i.e., allocation sites) in the program. The allocation site sensitivity instruction (160) may be incorporated into the analysis instructions (158) as an instruction to use allocation site sensitivity or may be incorporated by including a description describing how to perform a points-to analysis using allocation site sensitivity.

The field sensitivity instruction (162) instructs the language model (105) to track the fields of an object separate from the object itself to distinguish between different fields in a data structure. The field sensitivity instruction (162) may be incorporated into the analysis instructions (158) as an instruction to use field sensitivity or may be incorporated by including a description describing how to perform a points-to analysis using field sensitivity.

The one call site sensitivity instruction (165) instructs the language model (105) to use “1-callsite sensitivity” to track the most recent call sites (locations in the source code (112) where functions or methods are called) to distinguish different contexts within the source code (112) based on the last function or method call that led to the current point in a program generated from the source code (112). The one call site sensitivity instruction (165) may be incorporated into the analysis instructions (158) as an instruction to use one call site sensitivity or may be incorporated by including a description describing how to perform a points-to analysis using one call site sensitivity.

The analysis response (168) is the response generated by the language model (105) based on the analysis prompt (152). The analysis response (168) includes the points-to report (170).

The points-to report (170) is the out of a points-to analysis performed by the language model (105) responsive to the analysis prompt (152). The points-to report (170) may include text that identifies relationships between objects, variables, fields, methods, memory locations, etc., that may be used during the execution of a program generated from the source code (112). The points-to report (170) may identify which variables (or objects) a pointer variable can point to at different points in a program. The points-to report (170) may include multiple entries formatted using a structured text format (e.g., JavaScript object notation (JSON)). Each entry may identify a pair of references (e.g., objects, variables, fields, methods, etc.) from the source code (112), the type of alias between the pair of references, the sensitivity used to identify the alias, and an explanation of the alias between the pair of references.

The type of alias identifies the relationship between pointers or references that may point to the same memory location. The type of alias may be categorical, values of which may include “may alias”, “may not alias”, “must alias”, “must not alias”, etc.

The evaluation session (180) is the text exchanged with the language model (105). The evaluation session (180) includes the evaluation prompt (182) and the evaluation response (185).

The evaluation prompt (182) is a collection of data and instructions used to generate the revised points-to report (188) from the points-to report (170) and the normalized code (128). The evaluation prompt (182) includes the points-to report (170) and the normalized code (128). The evaluation prompt (182) may be executed multiple times to generate multiple versions of the revised points-to report (188).

The points-to report (170) (further described above) may be included with the evaluation prompt (182). The points-to report (170) may be included as text within the evaluation prompt (182) or may be included as a separate file provided with the evaluation prompt (182) to the language model (105).

The normalized code (128) (further described above) may be included with the evaluation prompt (182). The normalized code (128) may be included as text within the evaluation prompt (182) or may be included as a separate file provided with the evaluation prompt (182) to the language model (105).

The evaluation response (185) is the response generated by the language model (105) based on the evaluation prompt (182). The evaluation response (185) includes the revised points-to report (188).

The revised points-to report (188) is a revised version of the points-to report (170). The revised points-to report (188) may include confidence scores and reasons for each of the entries in the points-to report (170). The reasons provide a textual justification for the confidence scores.

The confidence scores are values that are identified by the language model (105). The confidence scores identify the correctness of the entries from the points-to report (170). The confidence scores may be categorical (“low”, “medium”, “high”, etc.). The confidence scores in different versions of the revised points-to report (188) may have different values for the same entry due to the stochastic nature of the language model (105), which may provide different output in response to the same input.

The aggregated points-to report (190) is an aggregated version of the revised points-to report (188). The aggregated points-to report (190) includes confidence scores that are aggregated from the confidence scores from multiple versions of the revised points-to report (188). One entry of the aggregated points-to report (190) may have a confidence score that is aggregated from the different confidence scores for the same entry in the different versions of the revised points-to report (188) generated by the analysis application (102).

FIG. 2 shows a flowchart of a method to generate points-to relations using language models. The method of FIG. 2 may be implemented using the system of FIG. 1, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) may generate points-to relations in the form of points-to reports using language models. The process (200) may include multiple steps that may execute on the components described in the other figures, including those of FIG. 1.

Block 202 includes executing a preprocessing session using one or more language models to process source code using one or more preprocessing prompts to generate metadata from the source code. The preprocessing prompts may be sent to one language model sequentially, i.e., an initial preprocessing prompt is sent, an initial preprocessing response is received, a subsequent preprocessing prompt is sent after receiving the initial preprocessing response, a subsequent preprocessing response is received, and so on and so forth, until each of the preprocessing prompts is processed by the language model. Different preprocessing prompts may be sent to different language models to be currently processed independently. When multiple language models are used, the different language models may be different instances of the same language model.

Executing the preprocessing session may include generating revised code from the source code by removing unreachable code from the source code responsive to a revision prompt of the one or more preprocessing prompts. To remove unreachable code, a control flow analysis may be performed to identify which parts of the code are not executed by examining the paths a program generated from the source code may take during execution. A data flow analysis may be performed to check how data moves through the program, identifying variables and code segments that are not used or that are assigned values that are not read. Once identified, the unreachable code is marked, which can include code within conditional statements that are false, loops that do not execute, or functions that are not called. The marked code may be removed from the source code.

Executing the preprocessing session may also include generating a precondition as part of the metadata for a method from revised code responsive to a conditioning prompt of the one or more preprocessing prompts. To generate a precondition for a method, the parameters the method takes may be analyzed to determine the types, expected ranges, constraints, etc., for the parameters. For example, if a method calculates the square root, the input should be a non-negative number. Additionally, the code for the method may be analyzed to determine the use of the input parameters and identify conditions or checks within the method that must be true for the method to execute correctly, such as checking for null values, ensuring numbers are within a certain range, verifying that collections are not empty, etc. Additionally, the method may be executed (or its execution may be simulated) with different sets of inputs to observe the behavior of the method to record inputs that may cause the method to fail or produce incorrect results.

Executing the preprocessing session may also include generating a post condition for the method from the revised code responsive to the conditioning prompt of the one or more preprocessing prompts. To generate a post condition for a method, the code of the method may be analyzed to identify the input parameters, return values, and modifications made during method execution, which may include the ranges of values input, used, or returned by the method. The method may be executed (or its execution may be simulated) with different sets of inputs to observe the behavior of the method to identify conditions that may be true after the method executes.

Executing the preprocessing session may also include generating the normalized code from revised code by retaining a set of statements from the revised code responsive to a normalization prompt of the one or more preprocessing prompts. The set of statements that are retained may include one or more memory allocation statements. The set of statements may be exclusively retained. When the set of statements are exclusively retained, other statements, e.g., statements that do not relate to memory allocation, may be deleted or otherwise removed from the source code to form the normalized code.

Block 205 includes executing an analysis session using the one or more language models to process the metadata using an analysis prompt to generate a points-to report for the source code from the metadata. Executing the analysis session may include combining the information from the metadata with analysis instructions to form the analysis prompt, which is sent to a language model. The analysis session may execute after the preprocessing session on a language model that may be different from the one or more language models used to process the preprocessing prompts.

Executing the analysis session may also include generating the points-to report responsive to the analysis prompt using analysis instructions including an allocation site sensitivity instruction, a field sensitivity instruction, and a one call site sensitivity instruction. The sensitivity instructions included within the analysis instructions expressly state that the points-to analysis performed by the language model is an analysis that uses the sensitivities identified in the sensitivity instructions. For example, the analysis prompt may include analysis instructions with the text “perform a points-to analysis on the provided code utilizing allocation site sensitivity, field sensitivity, and 1-callsite sensitivity”. Additionally, analysis prompt may include an example with example source code and an example points-to report that utilizes the sensitivities identified within the sensitivity instructions.

Executing the analysis session may also include generating the points-to report using smashing semantics for a collection from the source code responsive to the analysis prompt. A collection defined in the source code may be an object that collects other objects, which may be referred to as items. Examples of collections include lists, queues, stacks, etc. The use of smashing semantics in a points-to analysis that generates the points-to report may treat the collection and each of the items within the collection as the same object.

Executing the analysis session may also include generating the points-to report using a structured data format. For example, the data for the points-to report may be output as a set of key value pairs using a predefined format, such as JavaScript object notation. (JSON).

Block 208 includes executing an evaluation session using the one or more language models to process the points-to report and normalized code from the metadata using an evaluation prompt to generate a revised points-to report including a confidence score for an entry in the points-to report. A conference score may be generated for each entry in the points-to report. Executing the evaluation session may include executing the evaluation prompt multiple times to generate multiple revised points-to reports. Different evaluation sessions may be concurrently executed on different language models.

Executing the evaluation session may also include aggregating multiple confidence scores for the entry in the multiple revised points-to reports to generate an aggregated confidence score for the entry. For example, when the confidence scores are categorical, the aggregated value may be the median value of the multiple confidence scores.

Executing the evaluation session may also include generating an aggregated points-to report including the aggregated confidence score in place of the confidence score for the multiple confidence scores for the same entry. In other words, the aggregated points-to report may include an entry from the revised points-to report but the confidence score from the revised report may be replaced with the aggregated confidence score generated by aggregating the multiple confidence scores from the multiple revised points-to reports.

Executing the evaluation session may also include generating an aggregated points-to report by removing a divergent entry from the revised points-to report based on an aggregated confidence score, for the divergent entry, using an aggregation threshold. For example, when the number of confidence scores equal to the median value of the confidence scores divided by the total number of confidence scores for the entry is less than the aggregation threshold (e.g., 30%), then the entry may be removed.

The process (200) may also include generating a call graph using an aggregated points-to report generated from the revised points-to report. To generate a call graph using a points-to report, the points-to report may be parsed to identify information about the objects or memory locations each variable may point to. A pointer assignment graph (PAG) may be constructed from the points-to report, representing the relationships between pointers and the objects pointed to. Next, the points-to information may be propagated through the pointer assignment graph, to analyze the flow of pointers and corresponding assignments to determine the potential targets of function calls. The call sites in the code are identified, including both direct and indirect calls. Using the points-to information, indirect calls are resolved by determining the possible functions that may be called at each call site. The call graph is constructed by connecting the call sites to corresponding target functions, with each node in the call graph representing a function and each edge representing a call from one function to another.

The process (200) may also include optimizing the source code with a compiler using an aggregated points-to report generated from the revised points-to report. Multiple types of optimizations may be made using the aggregated points-to report. Types of optimizations may include removing redundant null checks, inlining function calls, moving invariant code out of loops, etc. For each type of optimization, the aggregated points-to report may be analyzed to identify the location in the source code that corresponds to the optimization. The source code may then be modified to implement the optimization at the location identified using the aggregated points-to report.

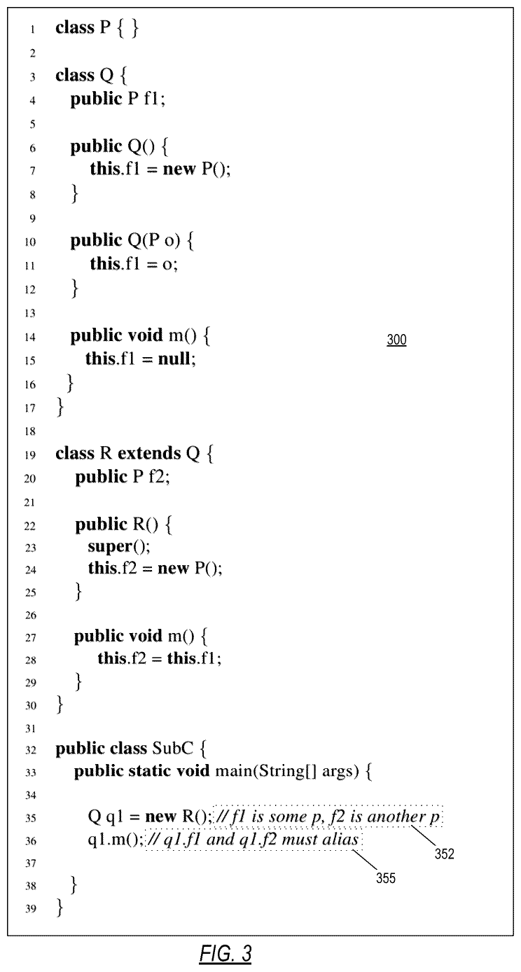

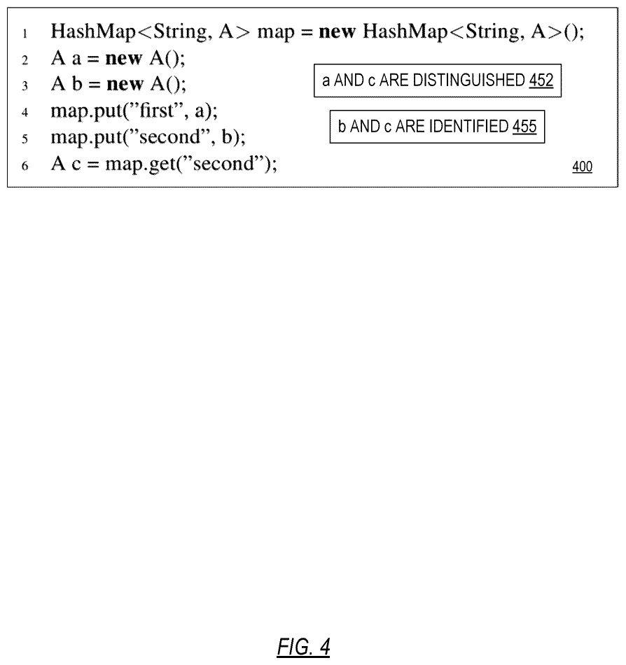

Turning to FIG. 3, the source code (300) may be displayed in the user interface of an IDE. The source code (300) includes the comments (352) and (355). The comments (352) and (355) may be automatically added to the source code (300) by the IDE in response to processing an original version of the source code (300) that did not include the comments (352) and (355).

The original version of the source code (300) may be processed by an analysis application using multiple sessions with a language model to generate a points-to report (which may be an aggregated points-to report) that contains entries with the alias information provided in the comments (352) and (355). After generating the points-to report, the IDE modifies the original version of the source code (300) to form the version of the source code (300) shown in FIG. 3.

Turning to FIG. 4, the source code (400) may be displayed in the user interface of an IDE. The source code (300) includes the popups (452) and (455).

An original version of the source code (400) may be processed by an analysis application using multiple sessions with a language model to generate a points-to report (which may be an aggregated points-to report) that contains entries with the alias information provided in the comments (452) and (455). After generating the points-to report, the IDE displays the alias information in the comments (452) and (455) on top of the original version of the source code (400) FIG. 4.

Turning to FIG. 5, the user interface (500) displays the source code (502) and the points-to report (552). The points-to report (552) may be an aggregated points-to report that provides alias information for the objects identified in the source code (502).

Each entry in the points-to report (552), includes multiple key value pairs, using a structured data format. The value for the “objects” key in the entry (555) identifies the objects, from the source code (502), to which the entry (555) relates. The value for the “aliastype” key in the entry (555) identifies the type of alias between the objects. The value for the “sensitivity” key in the entry (555) identifies sensitivity used to generate the alias information within the entry (555). The value for the “explanation” key in the entry (555) includes a textual explanation describing the relation between the objects for the entry (555). The value for the “confidence” key in the entry (555) is a categorical score that identifies the confidence that the alias information for the entry (555) is correct. The value for the “reason” key in the entry (555) is a textual description that provides a reason for selecting the confidence score for the entry (555).

Embodiments may be implemented on a special purpose computing system specifically designed to achieve the improved technological result. Turning to FIG. 6A and FIG. 6B, the special purpose computing system (600) may include one or more computer processors (602), non-persistent storage (604), persistent storage (606), a communication interface (612) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores or micro-cores of a processor. The computer processor(s) (602) includes one or more processors. The one or more processors may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (608). The inputs may include text input, audio input, video input, etc., which may be processed and transmitted by the computing system (600) in accordance with the disclosure. The communication interface (612) may include an integrated circuit for connecting the computing system (600) to a network (not shown) (e.g., a local area network (LAN), a wide area network (WAN) such as the Internet, mobile network, or any other type of network), and/or to another device, such as another computing device.

Further, the output device(s) (608) may include a display device, a printer, external storage, or any other output device. One or more of the output device(s) (608) may be the same or different from the input device(s) (610). The input device(s) (610) and the output device(s) (608) may be locally or remotely connected to the computer processor(s) (602). Many different types of computing systems exist, and the aforementioned input device(s) (610) and output device(s) (608) may take other forms. The output device(s) (608) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (600) in FIG. 6A may be connected to or be a part of a network. For example, as shown in FIG. 6B, the network (620) may include multiple nodes (e.g., node X (622) and node Y (624)). Each node may correspond to a computing system, such as the computing system (600) shown in FIG. 6A, or a group of nodes combined may correspond to the computing system (600) shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626), including receiving requests and transmitting responses to the client device (626). For example, the nodes may be part of a cloud computing system. The client device (626) may be a computing system, such as the computing system (600) shown in FIG. 6A. Further, the client device (626) may include and/or perform all or a portion of one or more embodiments of the disclosure.

The computing system (600) of FIG. 6A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or a semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
executing a preprocessing session using one or more language models to process source code using one or more preprocessing prompts to generate metadata from the source code;
executing an analysis session using the one or more language models to process the metadata using an analysis prompt to generate a points-to report for the source code from the metadata; and
executing an evaluation session using the one or more language models to process the points-to report and normalized code from the metadata using an evaluation prompt to generate a revised points-to report comprising a confidence score for an entry in the points-to report.

2. The method of claim 1, wherein executing the evaluation session comprises:
executing the evaluation prompt a plurality of times to generate a plurality of revised points-to reports;
aggregating a plurality of confidence scores for the entry in the plurality of revised points-to reports to generate an aggregated confidence score for the entry; and
generating an aggregated points-to report comprising the aggregated confidence score in place of the confidence score of the plurality of confidence scores.

3. The method of claim 1, wherein executing the evaluation session comprises:
generating an aggregated points-to report by removing a divergent entry from the revised points-to report based on an aggregated confidence score, for the divergent entry, using an aggregation threshold.

4. The method of claim 1, wherein executing the preprocessing session comprises:
generating revised code from the source code by removing unreachable code from the source code responsive to a revision prompt of the one or more preprocessing prompts.

5. The method of claim 1, wherein executing the preprocessing session comprises:
generating a precondition as part of the metadata for a method from revised code responsive to a conditioning prompt of the one or more preprocessing prompts; and
generating a post condition for the method from the revised code responsive to the conditioning prompt of the one or more preprocessing prompts.

6. The method of claim 1, wherein executing the preprocessing session comprises:
generating the normalized code from revised code by retaining a set of statements from the revised code responsive to a normalization prompt of the one or more preprocessing prompts,
wherein the set of statements that are retained include one or more memory allocation statements, and
wherein the set of statements are exclusively retained.

7. The method of claim 1, wherein executing the analysis session comprises:
generating the points-to report responsive to the analysis prompt using analysis instructions comprising an allocation site sensitivity instruction, a field sensitivity instruction, and a one call site sensitivity instruction; and
generating the points-to report using smashing semantics for a collection from the source code responsive to the analysis prompt.

8. The method of claim 1, wherein executing the analysis session comprises:
generating the points-to report using a structured data format.

9. The method of claim 1, further comprising:
generating a call graph using an aggregated points-to report generated from the revised points-to report.

10. The method of claim 1, further comprising:
optimizing the source code with a compiler using an aggregated points-to report generated from the revised points-to report.

11. A system comprising:
at least one computer processor; and
an application that, when executing on the at least one computer processor, performs operations comprising:
executing a preprocessing session using one or more language models to process source code using one or more preprocessing prompts to generate metadata from the source code;
executing an analysis session using the one or more language models to process the metadata using an analysis prompt to generate a points-to report for the source code from the metadata; and
executing an evaluation session using the one or more language models to process the points-to report and normalized code from the metadata using an evaluation prompt to generate a revised points-to report comprising a confidence score for an entry in the points-to report.

12. The system of claim 11, wherein executing the evaluation session comprises:
executing the evaluation prompt a plurality of times to generate a plurality of revised points-to reports;
aggregating a plurality of confidence scores for the entry in the plurality of revised points-to reports to generate an aggregated confidence score for the entry; and
generating an aggregated points-to report comprising the aggregated confidence score in place of the confidence score of the plurality of confidence scores.

13. The system of claim 11, wherein executing the evaluation session comprises:
generating an aggregated points-to report by removing a divergent entry from the revised points-to report based on an aggregated confidence score, for the divergent entry, using an aggregation threshold.

14. The system of claim 11, wherein executing the preprocessing session comprises:
generating revised code from the source code by removing unreachable code from the source code responsive to a revision prompt of the one or more preprocessing prompts.

15. The system of claim 11, wherein executing the preprocessing session comprises:
generating a precondition as part of the metadata for a method from revised code responsive to a conditioning prompt of the one or more preprocessing prompts; and
generating a post condition for the method from the revised code responsive to the conditioning prompt of the one or more preprocessing prompts.

16. The system of claim 11, wherein executing the preprocessing session comprises:
generating the normalized code from revised code by retaining a set of statements from the revised code responsive to a normalization prompt of the one or more preprocessing prompts,
wherein the set of statements that are retained include one or more memory allocation statements, and
wherein the set of statements are exclusively retained.

17. The system of claim 11, wherein executing the analysis session comprises:
generating the points-to report responsive to the analysis prompt using analysis instructions comprising an allocation site sensitivity instruction, a field sensitivity instruction, and a one call site sensitivity instruction; and
generating the points-to report using smashing semantics for a collection from the source code responsive to the analysis prompt.

18. The system of claim 11, wherein executing the analysis session comprises:
generating the points-to report using a structured data format.

19. The system of claim 11, further comprising:
generating a call graph using an aggregated points-to report generated from the revised points-to report.

20. A non-transitory computer readable medium comprising instructions executable by at least one computer processor to perform:
executing a preprocessing session using one or more language models to process source code using one or more preprocessing prompts to generate metadata from the source code;
executing an analysis session using the one or more language models to process the metadata using an analysis prompt to generate a points-to report for the source code from the metadata; and
executing an evaluation session using the one or more language models to process the points-to report and normalized code from the metadata using an evaluation prompt to generate a revised points-to report comprising a confidence score for an entry in the points-to report.
